(19) United States
(12) Patent Application Publication
(10) Pub. No.: US 2001/0003689 A1
(43) Pub. Date: Jun. 14, 2001

(54) Electrical connector with terminal retainer

(76) Inventor: Yun Sik Kim, Inchen City (KR)

Correspondence Address: Stacey E. Caldwell, Patent Counsel, Molex Incorporated, 2222 Wellington Court, Lisle, IL, 60532, US

(21) Appl. No.: 09/727,556

(22) Filed: Dec. 1, 2000

(30) Foreign Application Priority Data
Dec. 14, 1999 (KR) 99-28149

(51) Int. Cl. H01R 13/40

(52) U.S. Cl. 439/752; 439/595

(57) ABSTRACT

An electrical connector includes a dielectric housing having a plurality of cavities extending in an axial direction for receiving a plurality of terminals. Each terminal includes a locking shoulder. The housing includes a generally rectangular, bilaterally symmetrical opening in a side wall thereof communicating with the cavities. An elongated, generally rectangular and bilaterally symmetrical terminal retainer is positionable in the opening in the housing. The retainer has locking surfaces for engaging the locking shoulders of the terminals to hold the terminals inserted into the cavities. A tab on the housing projects into the opening at an edge thereof, and a notch is formed in the terminal retainer at a periphery thereof, for accommodating the tab to allow the terminal retainer to be positioned in the opening in only one orientation.

### FIELD OF THE INVENTION

This invention generally relates to the art of electrical connectors and, particularly, to an electrical connector having a retainer for locking terminals in a connector housing.

### BACKGROUND OF THE INVENTION

A typical electrical connector includes a dielectric housing having a plurality of terminal-receiving cavities or passages into which male or female terminals are inserted. Often, the cavities are generally parallel and elongated, and the terminals also are elongated and inserted into the cavities along longitudinal axes. In a hard wired connector, each terminal normally is crimped to a wire conductor and then inserted into one of the cavities. The housing may have primary locking means, such as flexible locking arms, for holding the terminals in their fully inserted positions. Mating plug and socket housings then can be joined in order to interconnect male and female terminals mounted in the housings, or the housing might be joined with other terminal supporting devices.

Although connectors of the character described above have been generally successful, unreliable interconnections between the terminals can occur in some instances. For example, a terminal may not be fully inserted into its housing cavity during assembly, whereby the locking structure is not effective to secure the terminal in place. In addition, even if a connection is made initially, a terminal can subsequently work loose because of vibrations or other extraneous forces and cause a faulty or intermittent connection. Such occurrences might be expected in such applications as automotive electrical systems which are subject to vibration and impact during normal use. Consequently, a variety of systems have been designed wherein a separate terminal retainer is employed on the connector housing to act as either a primary or a secondary locking means. These retainers may be inserted into openings in the connector housing in a direction generally perpendicular to the axes of the cavities. The retainers, themselves, are elongated generally transversely of the cavities to span a plurality of cavities and terminals. The openings in the housings communicate with the cavities so that the retainers can lockingly engage the terminals in the cavities. Examples of locking connectors are shown in Japanese Utility Model Publication Nos. Hei 1 (1989)-43986 and 64872 as well as in U.S. Pat. No. 5,203,722.

A major problem with independent retainers of the character described above is to ensure that a retainer is inserted into its opening in the housing in a proper orientation so that forcible insertion of the retainer does not damage the delicate terminals in the terminal-receiving cavities. The present invention is directed to providing a very simple means which allows a terminal retainer to be positioned in the opening in a housing in only one, proper orientation.

### SUMMARY OF THE INVENTION

An object, therefore, of the invention is to provide a new and improved electrical connector of the character described, incorporating a novel terminal retainer.

In the exemplary embodiment of the invention, the electrical connector includes a dielectric housing having a plurality of generally parallel elongated terminal-receiving cavities extending in an axial direction. A generally rectangular, bilaterally symmetrical opening is provided in a side wall of the housing. The opening is elongated in a direction generally transversely of the axial direction and communicating with the cavities. A plurality of generally elongated terminals are insertable into the cavities. Each terminal includes first and second locking shoulders. Primary interengaging locking means are provided between the housing and the first locking shoulders of the terminals to hold the terminals inserted into the cavities.

The invention contemplates an elongated, generally rectangular, bilaterally symmetrical terminal retainer positionable in the opening the housing in a direction generally perpendicular to the axial direction. Secondary interengaging locking means are provided between the terminal retainer and the second locking shoulders of the terminals to hold the terminals inserted into the cavities. A tab on the housing projects into the opening at an edge thereof, and a notch is provided in the terminal retainer at a periphery thereof for accommodating the tab, to allow the terminal retainer to be positioned in the opening in only one orientation. As disclosed herein, the tab on the housing and the notch in the terminal retainer are located at respective corners of the rectangular opening and the rectangular retainer.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an axial section through a connector of the type shown in U.S. Pat. No. 5,203,722 (see “Background”, above);

FIG. 2 is an exploded perspective view of an electrical connector assembly having a plug connector incorporating the concepts of the invention;

FIG. 3 is a perspective view of the plug connector, with the terminal retainer removed from the housing;

FIG. 4 is a fragmented axial section through one of the terminals of the plug connector;

FIG. 5 is an axial section through the connector housing without the terminals and with the terminal retainer in its first, preliminary position; and

FIG. 6 is a view similar to that of FIG. 5, with the terminals inserted into the housing and with the terminal retainer in its second, fully inserted position.

### DETAILED DESCRIPTION OF THE PREFERRED EMBODIMENT

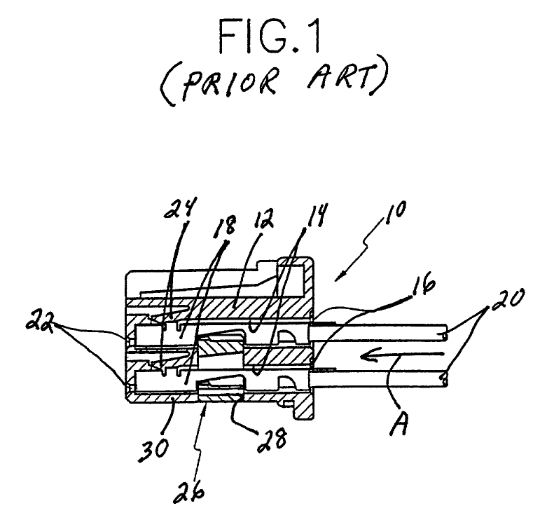

Referring to the drawings in greater detail, and first to FIG. 1, a conventional electrical connector, generally designated 10, is shown as disclosed in U.S. Pat. No. 5,203,722 which is listed in the “Background”, above. This prior art connector includes a housing 12 having a plurality of terminal-receiving cavities 14. The cavities have rear openings 16 into which a plurality of female terminals 18 are inserted in the direction of arrow “A” . The rear ends of the terminals are crimped and terminated to a plurality of discrete electrical wires 20. The cavities have front ends 22 into which male terminals are inserted for connection with the female terminals. A primary locking arm 24 is molded integrally with housing 12 and projects into each cavity 14 for locking engagement with the respective terminal 18 in the cavity.

Prior art connector 10 in FIG. 1 includes a secondary locking means in the form of a terminal retainer, generally designated 26, which is insertable through an opening 28 in a side wall 30 of housing 12. Although not visible in FIG. 1, opening 28 in the housing is generally rectangular, elongated and bilaterally symmetrical. Terminal retainer 26 also is generally rectangular, elongated and bilaterally symmetrical. Therefore, the retainer can be inserted into the opening in different orientations approximately 180° from each other. If the terminal retainer is inserted in the wrong orientation, it will not function properly, and/or the retainer might damage terminals 18 which are delicate and fabricated of thin sheet metal material.

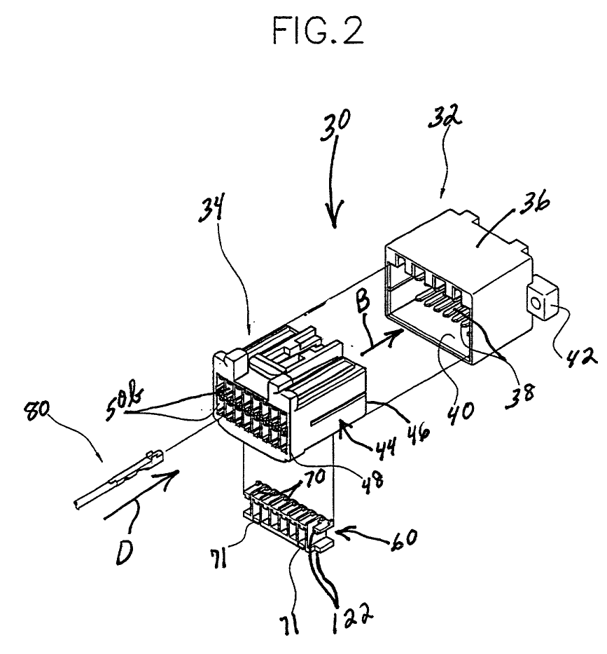

FIG. 2 shows a connector assembly, generally designated 30, which includes a receptacle connector, generally designated 32, mateable with a plug connector, generally designated 34. As will be seen hereinafter, the invention herein is incorporated in plug connector 34.

Receptacle connector 32 of connector assembly 30 includes a dielectric housing 36 mounting a plurality of male or pin terminals 38. Housing 36 defines a receptacle 40 into which plug connector 34 is inserted in the direction of arrow “B” to mate the connectors. Housing 36 may include one or more apertured mounting flanges 42 for mounting the receptacle connector to a panel, printed circuit board or the like. Male terminals 38 may have tail portions (not shown) for termination to circuit traces on the printed circuit board.

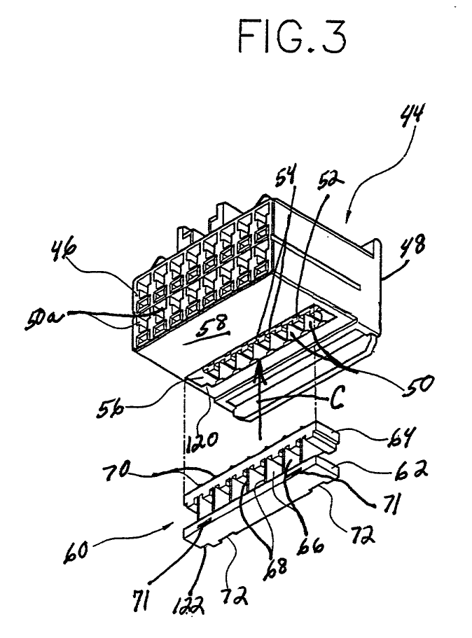

Referring to FIG. 3 in conjunction with FIG. 2, plug connector 34 of connector assembly 30 includes a dielectric housing, generally designated 44, which is a one-piece structure unitarily molded of dielectric material such as plastic or the like. The housing has a front mating end or face 46 and a rear terminating end or face 48. Two rows of terminal-receiving passages 50 (FIG. 3) extend in an axial direction through housing 44 between front and rear faces 46 and 48, respectively. The passages have front ends 50a which open at front face 46 of the housing, and the cavities have rear ends 50b opening at rear face 48 of the housing. As seen in FIG. 3, each cavity 50 has an elongated rib 52 defining a pair of grooves 54 on opposite sides thereof to facilitate guiding the terminals as they are inserted into the passages. FIG. 3 also shows a generally rectangular, bilaterally symmetrical opening 56 in a side (bottom) wall 58 of housing 44. The opening is elongated to span all of the terminal-receiving cavities laterally of the housing. The opening also extends into the housing communicating with the cavities.

A terminal retainer, generally designated 60, is positionable into opening 56 in housing 44. Like the opening, the terminal retainer is elongated, generally rectangular and bilaterally symmetrical. The retainer is inserted into the opening in the direction of arrow “C” (FIG. 3). Like housing 44, the terminal retainer is a one-piece structure unitarily molded of dielectric material such as plastic or the like. The retainer is formed by a pair of rectangular, parallel outer and inner plates 62 and 64, respectively, joined by a plurality of partitions or walls 66. The walls define passages 68 therebetween. A plurality of guide protrusions 70 project inwardly of inner plate 64 for guiding the inserted terminals. A pair of latch protrusions 71 project from one longitudinal edge of outer plate 62 for purposes described hereinafter. A pair of notches 72 along the other longitudinal edge of outer plate 62 allow the terminal retainer to be removed from the housing by a tool, such as a screwdriver.

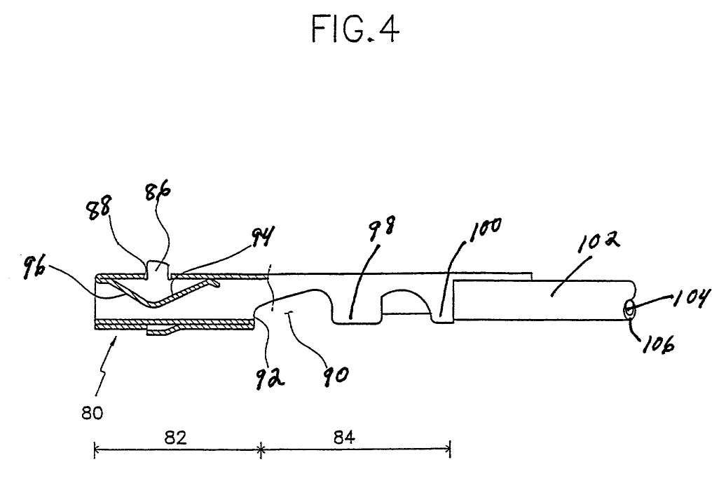

FIG. 4 shows one of a plurality of terminals, generally designated 80, which are inserted into the terminal-receiving passages of housing 44 in the direction of arrow “D” (FIG. 2). Each terminal includes a contact section and a terminating section shown schematically at 82 and 84, respectively, in FIG. 4. Each terminal is stamped and formed of conductive sheet metal material. Contact section 82 of the terminal includes a pair of upstanding ears 86 which are laterally spaced and which ride in guide grooves 54 (FIG. 3). The ears are formed out of an opening in the contact section which defines a first locking shoulder 88. A second opening 90 forms a second locking shoulder 92. A contact spring arm 94 is cantilevered rearwardly into contact section 82 for engaging one of the terminal pins 38 (FIG. 2) of receptacle connector 32. The contact spring arm has a front sloped surface 96 for engagement by the terminal pin. Finally, terminating section 84 has two pairs of crimp arms 98 and 100 for crimping onto an electrical wire 102. Crimp arms 98 conductively engage a conductor or core 104 of the electrical wire which has been stripped of an outer cladding 106. Crimp arms 100 clamp onto the outer cladding to provide strain-relief means for the wire.

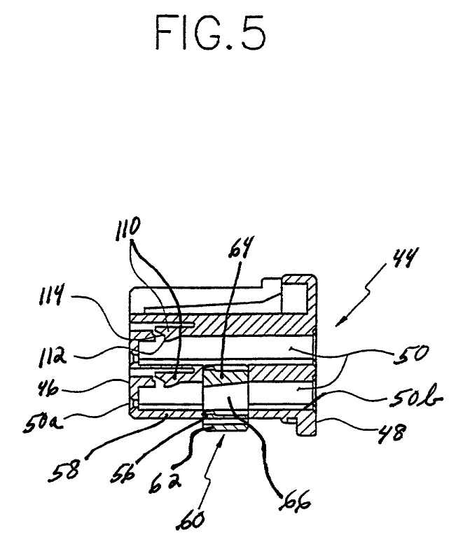

FIG. 5 shows an axial section through housing 44 of plug connector 34, with terminal retainer 66 in a first or preliminary position of mounting on the housing. In this position, latch protrusions 71 (FIGS. 2 and 3) along one edge of outer plate 62 establish a press-fit with wall 58 of the housing to hold the retainer in its preliminary position. In this first or preliminary position, all of the terminals 80 are freely insertable into cavities 50 through openings 50b at rear face 48 of the housing.

Before proceeding, FIG. 5 also shows the primary locking means for the terminals. Specifically, a flexible locking arm 110 is molded integrally with housing 44 for each terminal-receiving passage 50 and includes a protrusion 112 projecting into the respective cavity. Protrusions 112 define locking shoulders 14 for engaging first locking shoulders 88 of terminals 80.

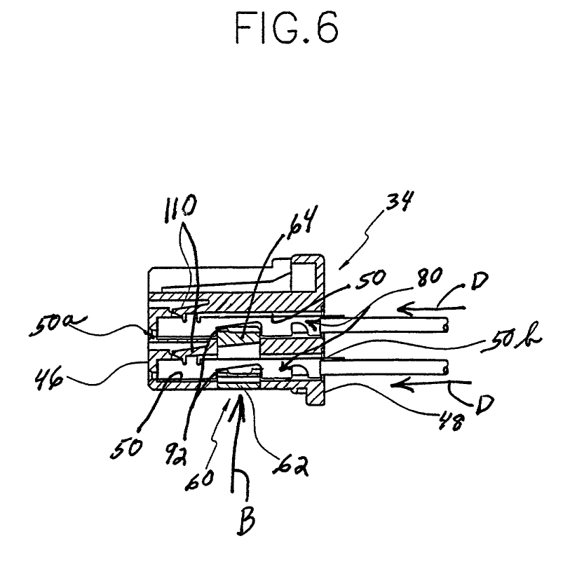

FIG. 6 shows plug connector 34 in fully assembled condition. Terminals 80 have been fully inserted into cavities 50 in housing 46 in the direction of arrows “D” . The terminals are in locking engagement with the primary locking means which includes locking arms 110 of the housing. Terminal retainer 60 has been fully inserted to its second or final position in the direction of arrow “B” whereat outer and inner plates 62 and 64, respectively, are in engagement with second locking shoulders 92 of the terminals.

Since opening 56 in housing 44 is rectangular and bilaterally symmetrical, and since terminal retainer 60 also is rectangular and bilaterally symmetrical, provision is made to ensure that the retainer can be inserted into the opening in only one orientation. To this end, FIG. 3 best shows that a tab 120 is formed integrally with the housing and projects into opening 56 at a corner of the rectangular opening. Correspondingly, as seen best in FIG. 2 and 3, a notch 122 is formed in a corner of each of the outer and inner plates 62 and 64, respectively, of the rectangular terminal retainer. Therefore, the retainer must be oriented as shown in FIG. 3 so that notches 122 on the retainer are aligned with tab 120 within the opening, before the retainer can be inserted into the opening. If the retainer is reversed, a corner of inner plate 64 of the retainer will abut the tab and prevent the retainer from being inserted into opening 56.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

I claim:

1. An electrical connector, comprising:
a dielectric housing having a plurality of generally parallel elongated terminal-receiving cavities extending in an axial direction, and a generally rectangular, bilaterally symmetrical opening in a side wall of the housing, the opening being elongated in a direction generally transversely of said axial direction and communicating with said cavities;
a plurality of generally elongated terminals insertable into the cavities, each terminal including first and second locking shoulders;
primary interengaging locking means between the housing and the first locking shoulders of the terminals to hold the terminals inserted into the cavities;
an elongated generally rectangular, bilaterally symmetrical terminal retainer positionable in the opening in the housing in a direction generally perpendicular to said axial direction;
secondary interengaging locking means between the terminal retainer and the second locking shoulders of the terminals to hold the terminals inserted into the cavities; and
a tab on the housing projecting into said opening at an edge thereof and a notch in the terminal retainer at a periphery thereof for accommodating said tab to allow the terminal retainer to be positioned in the opening in only one orientation.

2. The electrical connector of claim 1, including complementary interengaging latch means between the housing and the terminal retainer to hold the retainer on the housing in a first position allowing the terminals to be inserted into the cavities and a second position locking the terminals in the cavities.

3. The electrical connector of claim 1 wherein said tab on the housing and said notch in the terminal retainer are located at respective corners of the rectangular opening and the rectangular retainer.

4. An electrical connector, comprising:
a dielectric housing having a plurality of generally parallel elongated terminal-receiving cavities extending in an axial direction, and a generally rectangular, bilaterally symmetrical opening in a side wall of the housing, the opening being elongated in a direction generally transversely of said axial direction and communicating with said cavities;
a plurality of generally elongated terminals insertable into the cavities, each terminal including a locking shoulder;
an elongated generally rectangular, bilaterally symmetrical terminal retainer positionable in the opening in the housing in a direction generally perpendicular to said axial direction;
interengaging locking means between the terminal retainer and the locking shoulders of the terminals to hold the terminals inserted into the cavities; and
a tab on the housing projecting into said opening at an edge thereof and a notch in the terminal retainer at a periphery thereof for accommodating said tab to allow the terminal retainer to be positioned in the opening in only one orientation.

5. The electrical connector of claim 4, including complementary interengaging latch means between the housing and the terminal retainer to hold the retainer on the housing in a first position allowing the terminals to be inserted into the cavities and a second position locking the terminals in the cavities.

6. The electrical connector of claim 4 wherein said tab on the housing and said notch in the terminal retainer are located at respective corners of the rectangular opening and the rectangular retainer.
